(19) United States
(12) Patent Application Publication
(10) Pub. No.: US 2015/0147478 A1
(43) Pub. Date: May 28, 2015

(54) Fire-Resistant Cellulose Material

(71) Applicant: Nature Tech LLC, Milwaukee, WI (US)

(72) Inventor: Thomas C. Shutt, Milwaukee, WI (US)

(73) Assignee: Nature Tech LLC, Milwaukee, WI (US)

(21) Appl. No.: 14/089,142

(22) Filed: Nov. 25, 2013

(51) Int. Cl. C08K 5/098; B05D 1/02; C08K 5/092; C08K 3/32; C08K 3/30

(52) U.S. Cl. CPC C08K 5/098; C08K 3/32; C08K 3/30; C08K 5/092; B05D 1/02; C08K 2003/329; C08K 2003/309
USPC 427/427.7; 106/18.14; 106/18.11; 106/18.26

(57) ABSTRACT

A fire-resistant cellulose material composed of a liquid acid fire-retardant chemical composition and methods of producing the cellulose material are disclosed.

### FIELD OF THE INVENTION

Embodiments of the invention relate to fire-resistant cellulose products composed of liquid acid fire retardant(s), and methods of producing cellulose insulation and other products.

### BACKGROUND OF THE INVENTION

Cellulose is the framework (skeleton) for all plant fibers. After harvesting, retting and drying, the cellulose fibers from trees and plants such as cotton, flax, hemp, kenaf and jute, among others, are used to manufacture paper, insulation, building products, containers and many other items. Many of these products benefit from and/or have higher value by being fire retarded. With some products it is mandatory that they are fire retarded. Examples of mandated fire retarded products include numerous building materials such as but not limited to cellulose insulation, fire doors and certain types of cellulose-based board materials (e.g., panels), as well as automobile fabrics, furniture, etc.

Burning or combustion of cellulose fiber materials such as paper, cardboard, etc., generally involves two different chemical processes: a) flaming, which results from ignition of gases released by the pyrolysis of the cellulose fiber, and b) smolder, a slow, high temperature, flameless combustion which results from the oxidation of the remaining carbon-rich material, as with charcoal in a barbeque. The basic difference between smoldering and flaming combustion is that smoldering combustion occurs on the surface of a solid rather than in the gas phase.

Cellulose insulation is flammable and prone to smoldering, and it is well known in the cellulose insulation industry that chemical additions to a paper source material will increase its resistance to burning. It is also known that some chemicals will extinguish flaming but not smoldering combustion. Examples of such chemicals include borax pentahydrate, hydrated magnesium sulfate and aluminum trihydrate, among others. It is further known that other chemicals can extinguish both flaming and smolder. Examples of these chemicals include ammonium sulfate, ammonium phosphate and boric acid.

Cellulose insulation is required to meet federal regulations and Congress has mandated that cellulose insulation should not support burning under normal environmental conditions. The test methods that assure this property are set forth in ASTM C-739. Testing for flaming is carried out using critical radiant flux (CRF) equipment. In that test, a “pass” is achieved if the cellulose material will not support surface flame while being subjected to radiation of 0.12 watts/cm² or greater. Smolder testing is performed using a smolder box. A loss in weight of less than 15% of the original cellulose weight constitutes a “pass.”

In order to prevent flaming and smoldering combustion, most cellulose insulation is manufactured using fire retardant chemicals in powder form, such as hydrated borax, ammonium sulfate, aluminum trihydrate, etc. In order to meet federal standards for cellulose insulation, the loading of the powdered chemical is typically about 14 to 18% by weight (wt %) of the final insulation product. However, those chemicals are relatively expensive and their inclusion significantly raises the costs associated with the manufacture of a cellulose insulation product. In addition, the powder material dusts the cellulose particle surface, with a large portion of the powder being present in the product as loose dust particles.

By comparison, the application of a liquid form of the fire retardant chemical will penetrate the cellulose particles and requires a much lower loading of the fire retardant chemical, typically about 4 to 11 wt % of the final insulation product, which lowers raw material costs and results in appreciable cost savings. Liquid fire retardant compositions are described, for example, in U.S. Pat. No. 4,595,414 and U.S. Pat. No. 4,168,175 (Shutt). Examples of liquid fire retardant chemicals include aqueous solutions of ammonium sulfate, monoammonium phosphate, diammonium phosphate, ammonium tripolyphosphate, boric acid, ferrous sulfate, zinc sulfate, and mixtures thereof, dissolved in water. A disadvantage of currently known liquid fire retardant chemicals is that they can be corrosive or devolve ammonia, and can be expensive because of the amount of chemical required to extinguish fire.

Accordingly, it would be desirable from an industry standpoint to provide a cellulose material that would overcome the foregoing disadvantages, and can be produced at a low cost with liquid chemical only and possess the requisite level of fire retardance to meet government standards.

### SUMMARY

The present invention provides a fire-resistant cellulose fiber material and cellulose products, and methods of production.

In an embodiment, the invention is a fire-resistant cellulose fiber material comprising cellulosic fibers containing a liquid acid fire-retardant chemical composition or salt derivative thereof absorbed therein, and optionally an alkali applied thereto. According to the invention, the liquid acid composition is an aqueous solution that is applied to the cellulose fiber material to provide fire-resistance, and is composed of a fire-retardant chemical component that consists solely of one or more inorganic acids and/or organic acids as the fire retardant chemical component. In embodiments, the cellulose fiber material has a CRF value of 0.12 watts/cm² or greater, as measured according to ASTM C-739. The liquid composition can further include optional non-fire retardant additives such as a surfactant. In embodiments, a fire resistant cellulose insulation material has a settled bulk density of 1 to 2 lbs/ft³.

In embodiments, the liquid acid fire retardant chemical composition is an aqueous solution of at least one of sulfuric acid, boric acid (plus an ammonium salt), phosphoric acid, sulfurous acid, and mixtures thereof. In embodiments, the liquid acid fire retardant chemical composition is an aqueous solution of at least one of sulfuric acid, boric acid, phosphoric acid, acetic acid, citric acid, glycolic acid, and mixtures thereof. In embodiments, the liquid composition consists essentially of a mixture of sulfuric acid and phosphoric acid, sulfuric acid and citric acid, or phosphoric acid and citric acid. In embodiments, the liquid acid fire retardant chemical composition is phosphoric acid or a mixture of phosphoric acid and sulfuric acid and/or citric acid and/or acetic acid In embodiments, the alkali is selected from sodium carbonate, sodium hydroxide, potassium hydroxide, potassium carbonate, and mixtures thereof.

In an embodiment, the fire-resistant cellulose material (product) (e.g., insulation) comprises 94 to 85 wt % of cellulosic fibers, 4 to 13 wt % of the liquid acid fire-retardant chemical composition, 0 to 3 wt % of an alkali compound, and 0 to 0.2 wt % surfactant, the amounts based on the total weight of the cellulose material, wherein the material has a pH of at least 5.5, and typically 6 to 8.

In embodiments, the cellulose fiber material comprises, based on the total weight of the cellulose fiber material, 94 to 85 wt % of cellulose fibers, 6 to 15 wt % of an acid derived salt, and 0 to 0.2 wt % surfactant. In embodiments, the acid derived salt is a sulfate, phosphate, citrate or acetate. The cellulose fiber material is without the presence of an ammonium salt or ammonia residue therefrom.

In another embodiment, the invention is a method of producing a fire-resistant cellulose fiber material.

In an embodiment, the method comprises the steps of applying a liquid fire-retardant chemical composition to a cellulose material to produce a fire retardant-soaked (i.e., moistened or wetted) cellulose material having the fire retardant chemical composition absorbed therein, the liquid composition consisting essentially of one or more acids as the fire retardant chemical component in an aqueous solution; optionally, applying an aqueous alkali solution to the cellulose material such that the cellulose material has a pH of at least 5.5, preferably pH 6 to 8; and reducing the cellulose material in size to produce the fire-resistant cellulose fiber material having the liquid acid fire-retardant chemical absorbed therein. In embodiments, applying the liquid acid fire-retardant chemical composition and the alkali solution is by spraying.

In embodiments, the liquid fire-retardant chemical composition consists essentially of an aqueous solution of phosphoric acid or a mixture of phosphoric acid and a minor amount of an acid selected from the group consisting of sulfuric acid, citric acid and acetic acid. The term “minor amount” as used herein means that the acid is present at less than 50% of the total acid within the aqueous solution. In embodiments, the liquid fire-retardant chemical composition consists essentially of an aqueous solution of phosphoric acid, wherein, in embodiments, no aqueous alkali solution is applied to the cellulose material.

Unless otherwise indicated, all numbers expressing quantities of ingredients, properties such as reaction conditions, and so forth as used in the specification and claims are to be understood as being modified in all instances by the term “about.”

As used herein, the term “liquid acid fire retardant chemical composition” and like terms, means an aqueous solution composed solely of one or more inorganic and/or organic acids as the fire-retardant chemical component, without powdered fire-retardant chemicals. A liquid acid fire retardant chemical composition can optionally include one or more non-fire retardant additives (e.g., surfactants).

“Composition” and like terms mean a mixture or blend of two or more components.

As used herein, the term “fire” refers to the process of burning of cellulose by flame or smolder. The terms “flame” and “flammable” refer to the burning of gases resulting from pyrolysis due to heat. The term “smolder” or smoldering combustion refers to the burning of a carbon-rich material remaining after gases have devolved (e.g., as with charcoal in a barbeque). Both burning processes can be chemically tested by the methods, for example, as outlined in ASTM C-739 (Standard Specification for Cellulosic Fiber Loose-Fill Thermal Insulation) and as mandated by law.

As used herein, the term “fire resistant” means resistance to flaming and smoldering combustions. The term “fire-retardant chemical” refers to a chemical substance or mixture (other than water) that reduces flammability or smolder of a cellulose material.

Unless stated to the contrary, implicit from the context, or customary in the art, all parts and percentages are based on weight.

### DESCRIPTION OF THE INVENTION

The present invention relates to a fire-resistant cellulose (e.g., paper-based) product composed of an absorbed acid component as the sole fire retardant compound, and methods of producing the cellulose product.

The methods utilize a liquid fire retardant chemical composition consisting of an aqueous solution of one or more inorganic and/or organic acids as the sole fire retardant component to produce a cellulose product composed of cellulosic fibers containing the liquid fire-retardant chemical composition absorbed therein. The cellulose product of the invention possesses a high level of fire resistance at a much lower cost than other cellulose-based products. The products and methods of the invention avoid the use of powdered (dry) fire retardant compositions.

The invention utilizes an aqueous solution of one or more inorganic and/or organic acids in the production of the fire-resistant cellulose product. In fabricating the cellulose product, no dry powdered fire retardant compounds are applied to or included in the cellulose material. The use of an aqueous acid solution as the fire retardant component of the liquid fire retardant chemical composition lowers costs in the manufacturing of the cellulose product, e.g., insulation, and also eliminates potential problems of corrosiveness and odor, which can occur in the use of conventional powdered fire retardants. In embodiments, an aqueous alkali solution is applied to neutralize the acid such that the cellulose material has a pH of 6 to 8.

Processes for applying liquid fire-retardant compositions to cellulose materials are known in the art, as described, for example, in U.S. Pat. No. 5,534,301 (Shutt).

### Shredder

Briefly, a supply of cellulose-containing material can be loaded onto a feed table where the cellulose material can be sorted and separated from non-cellulose materials, and then conveyed into a shredding apparatus to physically reduce the cellulose material to a desired size (e.g., pieces of paper), for example, a typical average width and length of 0.5 to 2 inches (0.25 to 5 cm). Cellulose-containing materials typically comprise wood or other plant materials, for example, cotton, flax, hemp, kenaf and jute, among others, known and used in the art for producing cellulose-based materials, for example but not limited to, unused or used (recycled) paper such as newspaper, cardboard, fiberboard, paperboard, etc. The shredding apparatus may involve different types of standard systems known in the art.

### Spray Booth

In embodiments, the liquid acid fire retardant chemical composition is then applied to wet (moisten) the reduced size cellulose material. In a preferred embodiment, the liquid fire retardant chemical composition is delivered in a spray booth using a spraying system that can include one or more spraying nozzles connected to a source of the liquid fire retardant composition, e.g., a tank. Spray booths are well known in the art. The liquid composition can be delivered onto the cellulose material in a fine mist composed of a plurality of droplets (e.g., droplets 40 to 200 microns in diameter). Application of the liquid fire retardant chemical composition produces a fire retardant shredded cellulose material that is moistened (wetted) with the liquid fire retardant chemical composition.

For some applications, immersion of the reduced size cellulose material in the liquid fire retardant chemical is preferred, for example, when manufacturing insulation blankets from fibers such as flax and jute for use in the automobile market. In such an application, the reduced size cellulose material can be immersed in a bath containing the liquid fire retardant chemical, and then dried. Optionally, to remove excess liquid prior to drying, the cellulose material can be passed through a dewatering device such as a vacuum screening apparatus or rollers.

### Liquid Fire Retardant Chemical

Although acids are destructive to paper, it was surprisingly found that the application of an aqueous solution of an acid onto a cellulose material, without the application of a conventional, powdered fire retardant chemical such as hydrated borax, ammonium sulfate, aluminum trihydrate, etc., followed by the application of a liquid alkali material, will render the cellulose material fire resistant to both flame and smolder combustion. Although not intended to be a limitation to the present disclosure, it is believed that the acid hydrolyzes the cellulose material through the donation of a proton (H⁺), which causes breaking of the covalent bonds that hold the glucose rings together, which in turn leads to a reaction (under heat) that provides a flame retarding effect and increases the fire resistance of the cellulose product, e.g., insulation. The application of an alkali onto the acid-treated cellulose material counteracts the hydrolytic activity by the acid and produces a substantially pH neutral material, i.e., pH 6 to 8. The neutralizing of the acid by the alkali addition prevents an excessive degradation of the paper.

In general, the liquid acid fire retardant chemical composition can comprise any inorganic and/or organic acid which imparts fire resistance to the cellulose materials. Preferred acids are those that are non-toxic. Examples of suitable acids include strong inorganic acids such as sulfuric acid; weak inorganic acids such boric acid, phosphoric acid and sulfurous acid; and weak organic acids such as acetic acid, citric acid, fumaric acid, glutaric acid, glyceric acid, glycolic acid, lactic acid, oxalic acid, propenoic acid, propanoic acid, salicylic acid, stearic acid, succinic acid, tartaric acid, carbonic acid, trichloroacetic acid, methanoic acid, benzoic acid, ethanoic acid, tartaric acid; and mixtures of any of the foregoing acids. Preferred acids include sulfuric acid, boric acid, phosphoric acid, sulfurous acid, acetic acid, citric acid and glycolic acid, and mixtures thereof, with sulfuric acid being a more preferred acid. Non-limiting examples of preferred mixtures of acids include aqueous solutions of sulfuric acid and phosphoric acid, and sulfuric acid and citric acid.

In embodiments, the acid concentration in aqueous solution (i.e., the liquid acid fire-retardant chemical composition), is at least 5%, more typically at least 10%, more typically at least 15%, up to 50%, more typically up to 40%, more typically up to 30%, more typically up to 25%, and more typically up to 20%. In a preferred embodiment, sulfuric acid is used as the acid component as a 15% to 25% aqueous solution, preferably as a 20% aqueous solution.

The liquid acid fire retardant chemical composition comprises an effective amount of the acid such that its application will provide a cellulose material with a Critical Radiant Flux (CRF) value of at least 0.12 watts/cm², which will pass testing requirements, for example, the requirements according to ASTM C-739 (Standard Specification for Cellulosic Fiber Loose-Fill Thermal Insulation). For example, as illustrated by the test data in Table 1 below, a cellulose material that was sprayed with 15 wt % acid (“acid load”) from a 40% aqueous solution had a “passing” CRF value (i.e., at least 0.12 W/cm²) except for the 40% glycolic acid application.

TABLE 1

| | | Acid | CRF |
|---|---|---|---|
| Acid | Concentration (%) | Load (wt %) | (W/cm²) |
| Sulfuric | 40 | 15 | >0.45 |
| (1:9) Boric Acid/ | 40 | 15 | >0.45 |
| Ammonium Sulfate | | | |
| Phosphoric | 40 | 15 | 0.42 |
| Acetic | 40 | 15 | 0.12 |
| Citric | 40 | 15 | 0.12 |
| Glycolic | 40 | 15 | <0.10 |

The CRF values indicate the minimum radiant energy needed for a fire to sustain flame propagation, with a higher number indicating a more flame-resistant system, i.e., >0.45 W/cm² being better than 0.42 or 0.12 W/cm². A “pass” is achieved if the cellulose material will not support surface flame while being subjected to radiation of 0.12 watts/cm² or greater.

The results in Table 1 demonstrate the effectiveness of acid as a flame retarding additive to cellulose material. The data also demonstrates that stronger acids (e.g., sulfuric acid) are more effective in flame retarding ability than weaker acids (e.g., acetic acid, citric acid).

### Additives.

In order to enhance the wetting or impregnation of the cellulosic fiber material by the liquid fire retardant composition, a conventional wetting agent or surfactant may be included in the solution, such as a polyoxyethylene alkyl phenol, e.g. TRITON X-100 (manufactured by Rohm & Haas Co.). In embodiments utilizing a wetting agent or surfactant, the liquid acid fire-retardant chemical composition generally comprises 0.02 to 0.2 part of one or more wetting agents or surfactants, more typically 0.04 to 0.1 part, and more typically 0.1 part, based on 100 parts of water.

### Application of Liquid Fire-Retardant Composition

In applying the liquid composition, it was found that the better the coverage of the cellulose material by the acid, the less acid is required to pass the CRF test. This was determined by spraying a liquid composition having a lower acid content/higher water content, which provided greater area coverage of the pieces of the cellulose material than a liquid composition having a higher acid content, e.g., a 40% versus a 10% aqueous solution of sulfuric acid (H₂SO₄). This is illustrated by the test data summarized in Table 2 below, generated by using an aqueous solution of different concentrations of sulfuric acid (H₂SO₄) applied to the cellulose material by spraying the shredded, size-reduced cellulose material in a spray booth.

TABLE 2

| Sulfuric Acid | | |
|---|---|---|
| Concentration (%) | Acid Load (wt %)¹ | CRF (W/cm²) |
| 40 | 6.65 | 0.12 |
| 20 | 6.65 | 0.16 |
| 10 | 6.65 | 0.20 |

The application of the liquid fire retardant composition preferably produces a wetted/moistened cellulose material that comprises an amount of the liquid fire resistant composition such that the final cellulose product (e.g., insulation) contains at least 4 parts up to 12 parts, and more typically up to 8 parts of acid as the fire resistant chemical per 100 parts of the fire resistant product. The amount of acid that is applied will vary according to the acid, its strength and its dilution in aqueous solution, and should be sufficient to provide a CRF value of at least 0.12 W/cm².

### Application of Alkali.

The application of acid to the cellulose material will cause it to degrade. In addition, the use of acid as a flame retardant can lead to problems of metal corrosion upon use, e.g., after a cellulose insulation product is installed. To counteract the degradation of the cellulose material and eliminate problems with corrosion during use, a sufficient amount of an alkali compound can be applied to the cellulose material after the application of the acid component to neutralize the acid.

In general, any water-soluble alkali compound that will neutralize the acid can be applied to the acid-treated, cellulose material. The application of the alkali solution preferably produces a wetted/moistened cellulose material that comprises an amount of the alkali compound sufficient to adjust the cellulose material to a final pH of at least 5.5, preferably a pH of 6.0 to 8.0, preferably a pH of 7.0.

In the use of phosphoric acid as the liquid all acid composition, it was surprisingly found that the pH of the cellulose material remained higher than expected at pH 5.5, which eliminated the need for applying the alkali component to neutralize the acid.

Preferred alkalis are those with high water solubility. Non-limiting examples of alkalis suitable for use include sodium carbonate, sodium hydroxide, potassium hydroxide, potassium carbonate, and mixtures thereof. Preferred alkali compounds include sodium carbonate and sodium hydroxide. Treatment of the cellulose material with an aqueous alkali solution will result in the production of the corresponding salt of the acid (i.e., acid derived salt, or salt derivatives), for example, sulfates, phosphates, citrates, acetates, etc.

In embodiments, an aqueous solution of a water-soluble alkali compound can be sprayed onto the cellulose material after the application of the acid, preferably substantially immediately (e.g., within 0.1 to 1.0 minutes). The amount of alkali that is applied will vary according to the alkali, its concentration in aqueous solution, and the acid and amount of acid applied.

In embodiments, the aqueous solution of the water-soluble alkali compound comprises at least a 5%, more typically at least a 10%, more typically at least a 15%, up to 50%, more typically up to 40%, more typically up to 30%, more typically up to 25%, more typically up to 20%, aqueous solution of the alkali compound. In a preferred embodiment, sodium carbonate is used as the alkali component as a 5 to 20% aqueous solution, preferably as a 15% aqueous solution.

### Dwell Time (Optional)

Optionally, after the application of the alkali composition, a “dwell” time (delay period) can be allowed to elapse in order to ensure diffusion of the liquid fire retardant composition into the cellulose fibers and reaction of the alkali to neutralize the acid. For example, the wetted cellulose material can be held in a hopper or other containment vessel for a desirable time period, for example, up to 45 seconds to 120 seconds or longer.

### Drying

After the application of the liquid acid fire retardant, which in embodiments, is followed rapidly by the application of the alkali solution, the wetted cellulose material is dried to remove the added water from the applied liquids. Removal of the excess water through drying reduces the amount of dust produced in subsequent processing through the hammermill and/or fiberizer. In embodiments, the wetted cellulose material is transferred by a stream of air (e.g., heated air) into a drying chamber such as a rotary drier and a tumble drier, among others. In preferred embodiments, the dried cellulose material is “air dry” (e.g., 90 to 95% dry) having a 5% to 10% moisture content.

### Fiberizer/Hammer Mill

The dry, fire retardant-treated cellulose material can then be transferred, for example, by air flow, to a hammer mill, fiberizer or both, such as known and used in the art, to further reduce the size of the shredded material into smaller pieces, for example to an average length and width of 0.25 to 0.5 inches (0.6 to 1.25 cm). In embodiments, the cellulose material can be dried, for example, by applying heat to the wetted material prior to or during the transfer of the material.

Fiberizers and hammer mills are known and used in the art. The fiberizer, for example, is a mechanical device configured with rotating elements in close proximity to one or more sets of static or counter rotating elements such that when the cellulose material is conveyed through the device, a finely divided material is produced. Processing through the fiberizer reduces the size of the cellulose material to a desired, final reduced size, fluffy form. For a cellulose insulation product, it is preferred that the final product will have a settled bulk density of 1 to 2 lbs/ft³ (e.g., 1.2 to 1.6 lbs/ft³).

### Dedusting

The size reduction processing in the fiberizer/hammer mill typically produces a substantial quantity of dust (i.e., material with very small particle size), which contains residues and chemicals that can be easily inhaled and pose significant problems such as lack of visibility and personal nuisance due to a high amount of air-borne dust particles, particularly when the material is pneumatically applied, for example, as an insulation.

In embodiments, the fire-retardant cellulose fiber material can be de-dusted to eliminate a major amount (i.e., at least 50% by volume or more) to substantially all (i.e., about 90-100% by volume) of the dust, and produce a low-dust fire-retardant cellulose fiber material that has functionally equivalent fire-retardant properties as the fire-retardant cellulose fiber material before de-dusting. The de-dusted product can be characterized by a substantial absence of detached fibrous residue which, if present, can increase its density.

Such a dust removal (de-dusting process is described in US 2010/0086780 (Shutt). The de-dusting can be performed by any suitable process, for example, by screening, air classification, or other known separation techniques. Preferably, the de-dusting is performed by a screening technique or screening in combination with another separation technique.

In preferred embodiments, the screen has a mesh size that is suitable for effectively separating a sufficient amount of dust from the dried product, preferably to produce a substantially dust-free material by removing at least about 50% by volume of the dust content of the dried product, more preferably at least about 70%, and more preferably at least 90%, up to 100%, by volume of the dust. The mesh of the screen can range from about 200 mesh to about 10 mesh, and is preferably about 40 mesh to about 14 mesh, more preferably about 30 mesh to about 20 mesh. An example of a suitable screening apparatus for use in the de-dusting process of the invention is a gyratory (vibratory), high capacity, production separator or sieve (e.g., Models VS0048 (single deck) and VS0060 (double deck)), available commercially from VORTI-SIV®, a division of MM Industries, Inc., Salem, Ohio U.S.A.

A reduced-size dry cellulose product that has been processed according to the invention using a liquid fire-retardant chemical, will typically contain about 8-15% by weight dust composed of about 7.5-15% by weight cellulose-based (e.g., paper) dust with about 0.5-1.5% by weight of fire-retardant chemical adhered to the dust, and de-dusting according to the invention can remove a substantial amount of dust (up to 100% of the dust) from the reduced-size dry product with substantially no loss of fire-retardant properties.

### Final Product/Packaging

In an embodiment, the final fire-resistant cellulose product, e.g., insulation, based on the total weight of the product, comprises:

A. Cellulose fibers, being at least 80 wt %, more typically at least 85 wt %, more typically at least 90 wt %, up to 94 wt %;

B. One or more acids, at up to 20 wt %, more typically up to 15 wt %, more typically up to 10 wt %, and at least 4 wt % (e.g., sulfuric acid), applied as a 10 to 40% aqueous solution and then dried on the material;

C. Optionally, one or more alkali compounds, at up to 4 wt %, more typically up to 3 wt %, more typically up to 2 wt %, and more typically at least 0.1 wt % (e.g., Na₂CO₃), applied as a 10 to 20% aqueous solution and dried on the material; and

D. Optionally, a surfactant, typically up to 0.2 wt %.

In an embodiment, the final fire-resistant cellulose product, e.g., insulation, based on the total weight of the product, comprises:

A. Cellulose fibers, being at least 80 wt %, more typically at least 85 wt %, more typically at least 90 wt %, up to 94 wt %;

B. One or more acid derived salts, at up to 20 wt %, more typically up to 15 wt %, more typically up to 10 wt %, and at least 5 to 6 wt %; C. Optionally, a surfactant, at up to 0.2 wt %.

Examples of acid derived salts (salt derivatives) include sulfates, phosphates, citrates and acetates. The cellulose product is without the presence of an ammonium salt or ammonia residue therefrom.

The final cellulose product is treated with an amount of the acid component sufficient and effective to provide a level of fire retardance to meet federal standards for both the smoldering combustion test and the flame spread burn test, which for insulation is outlined in ASTM C-739 (Standard Specification for Cellulosic Fiber Loose-Fill Thermal Insulation). Where used, the amount of applied alkali is sufficient and effective to neutralize the acid and provide the cellulose material with a final pH of at least 5.5, preferably pH 6.0 to 8.0, and more preferably pH 7.0. In embodiments, the cellulose fiber material has a CRF value of 0.12 watts/cm² or greater, as measured according to ASTM C-739. The dried cellulose product can be deposited into a holding bin or conveyed to a bale press or baler or to a bagging apparatus, as known and used in the art, and packaged for transport and future use. In an installation process for insulation, the fire retarded cellulose insulation product can be placed into a hopper and mechanically fluffed-up, and then “blown” directly into an attic or stud spaces in an existing wall, among other applications.

The fire-resistant cellulose product of the invention can be used for producing fire-retarded products including building materials such as but not limited to cellulose insulation, fire doors and cellulose-based board materials (e.g., panels), as well as automotive fabrics, and furniture, among other articles.

In the present invention, the only chemical used for imparting fire resistance is acid, which is applied to the cellulose material exclusively as a liquid. Surprisingly, the applied liquid acid fire retardant chemical composition provides a cellulose insulation and other products having the required level of fire retardance to meet federal standards for both the smoldering combustion test and the flame spread burn test, while significantly reducing the cost of manufacture of the fire-resistant cellulose material, e.g., insulation, compared to cellulose material produced using only a powdered or other liquid fire retardant chemical. The use of an aqueous acid component as the sole fire retardant chemical in place of more expensive fire retardant chemicals such as hydrated borax, ammonium sulfate, aluminum trihydrate, etc., significantly lowers manufacturing costs.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations that operate according to the principles of the invention as described. Therefore, it is intended that this invention be limited only by the claims and the equivalents thereof. For purposes of United States patent practice, the contents of any referenced patent, patent application or publication are incorporated by reference in their entirety.

What is claimed is:

1. A fire-resistant cellulose fiber material, comprising cellulosic fibers containing a liquid fire-retardant chemical composition or salt derivative therefrom absorbed therein, the liquid composition consisting essentially of one or more acids as the fire retardant chemical component in an aqueous solution;
wherein the cellulose fiber material has a CRF value of 0.12 watts/cm² or greater, as measured according to ASTM C-739.

2. The cellulose fiber material of claim 1, wherein the acid is an inorganic acid selected from the group consisting of sulfuric acid, boric acid, phosphoric acid, sulfurous acid, and mixtures thereof.

3. The cellulose fiber material of claim 1, wherein the acid is an organic acid selected from the group consisting of trifluoroacetic acid, sulfonic acids, acetic acid, citric acid, fumaric acid, glutaric acid, glyceric acid, glycolic acid, lactic acid, oxalic acid, propenoic acid, propanoic acid, salicylic acid, stearic acid, succinic acid, tartaric acid, carbonic acid, trichloroacetic acid, methanoic acid, benzoic acid, ethanoic acid, and mixtures thereof.

4. The cellulose fiber material of claim 3, wherein the acid is selected from the group consisting of sulfuric acid, boric acid, phosphoric acid, acetic acid, citric acid, glycolic acid, and mixtures thereof.

5. The cellulose fiber material of claim 1, wherein the liquid composition consists essentially of a mixture of sulfuric acid and phosphoric acid, sulfuric acid and citric acid, or phosphoric acid and citric acid.

6. The cellulose fiber material of claim 1, consisting essentially of the cellulosic fibers and an acid absorbed therein.

7. The cellulose fiber material of claim 6, wherein the acid is phosphoric acid or a mixture of phosphoric acid and an acid selected from the group consisting of sulfuric acid, citric acid and acetic acid

8. The cellulose fiber material of claim 1, consisting essentially of the cellulosic fibers and the salt derivative of the one or more acids.

9. The cellulose fiber material of claim 8, wherein the salt derivative is selected from the group consisting of sulfates, phosphates, citrates and acetates, without the presence of an ammonium salt or ammonia residue therefrom.

10. The cellulose fiber material of claim 1, wherein the liquid fire-retardant composition further comprises a surfactant.

11. The cellulose fiber material of claim 1, wherein the cellulose fiber material has no fire retardant chemical in powder form contained therein or situated thereon.

12. The cellulose fiber material of claim 1, comprising, based on the total weight of the cellulose fiber material:
94 to 85 wt % of cellulose fibers;
4 to 13 wt % acid;
0 to 3 wt % alkali; and
0 to 0.2 wt % surfactant.

13. The cellulose fiber material of claim 12, wherein the alkali is selected from the group consisting of sodium carbonate, sodium hydroxide, potassium hydroxide, potassium carbonate, and mixtures thereof.

14. The cellulose fiber material of claim 1, comprising, based on the total weight of the cellulose fiber material:
94 to 85 wt % of cellulose fibers;
6 to 15 wt % of an acid derived salt; and
0 to 0.2 wt % surfactant.

15. The cellulose fiber material of claim 14, wherein the acid derived salt is selected from the group consisting of sodium sulfate, potassium sulfate, sodium phosphate, potassium phosphate, sodium citrate, potassium citrate, sodium acetate and potassium acetate.

16. The cellulose fiber material of claim 14, being without the presence of an ammonium salt or ammonia residue therefrom.

17. The cellulose fiber material of claim 1, having a settled bulk density of 1 to 2 lbs/ft³.

18. A fire-retarded insulation material comprising the cellulose fiber material of claim 1.

19. A fire-retarded article comprising the cellulose fiber material of claim 1.

20. The article of claim 19, selected from the group consisting of fire doors, board materials automotive fabrics, and furniture.

21. A method of producing a fire-resistant cellulose fiber material, comprising:
applying a liquid fire-retardant chemical composition to a cellulose material to produce a wetted, fire retardant-treated cellulose material having the fire retardant chemical composition absorbed therein, the liquid composition consisting essentially of one or more acids as the fire retardant chemical component in an aqueous solution;
optionally, applying an aqueous alkali solution to the cellulose material such that the cellulose material has a pH of 5.5 to 8; and
reducing the cellulose material in size to produce the fire-resistant cellulose fiber material.

22. The method of claim 21, wherein applying the liquid fire-retardant chemical composition is by spraying.

23. The method of claim 22, wherein the liquid fire-retardant chemical composition consists essentially of an aqueous solution of phosphoric acid or a mixture of phosphoric acid and a minor amount of an acid selected from the group consisting of sulfuric acid, citric acid and acetic acid.

24. The method of claim 23, wherein the liquid fire-retardant chemical composition consists essentially of an aqueous solution of phosphoric acid.

25. The method of claim 24, wherein no aqueous alkali solution is applied to the cellulose material.

26. The method of claim 21, wherein the liquid fire-retardant chemical composition consists essentially of an aqueous solution of an acid selected from the group consisting of sulfuric acid, boric acid, phosphoric acid, acetic acid, citric acid, glycolic acid, and mixtures thereof.

27. The method of claim 26, wherein an aqueous alkali solution is applied to the cellulose material.

28. The method of claim 27, wherein the alkali is selected from the group consisting of sodium carbonate, sodium hydroxide, potassium hydroxide, potassium carbonate, and mixtures thereof.
